(19) United States
(12) Patent Application Publication
(10) Pub. No.: US 2013/0324138 A1
(43) Pub. Date: Dec. 5, 2013

(54) METHOD AND APPARATUS FOR PERFORMING CHANNEL CODING TYPE CONTROL

(71) Applicant: MEDIATEK INC., Hsin-Chu (TW)

(72) Inventors: Lun-Han Chang, Taoyuan County (TW); Wei-De Wu, Hsinchu City (TW)

(73) Assignee: MEDIATEK INC., Hsin-Chu (TW)

(21) Appl. No.: 13/798,139

(22) Filed: Mar. 13, 2013

Related U.S. Application Data
(60) Provisional application No. 61/653,610, filed on May 31, 2012.

(51) Int. Cl. H04W 80/06

(52) U.S. Cl. CPC H04W 80/06
USPC 455/450

(57) ABSTRACT

A method and apparatus for performing channel coding type control are provided, where the method may include: obtaining a code block size to be used during channel encoding (or decoding) for a Transport Format (TF); comparing the code block size with at least one predetermined threshold to generate at least one comparison result; selecting a specific channel coding type from a plurality of channel coding types according to the at least one comparison result; and utilizing the specific channel coding type during channel encoding (or decoding) for the TF. It is an advantage that the method can utilize code-block-size-dependent channel coding types during channel encoding (or decoding), so the channel coding gain can be increased, and therefore the goal of improving the system capacity and reducing the power consumption can be achieved.

### CROSS REFERENCE TO RELATED APPLICATIONS

This application claims the benefit of U.S. Provisional Application No. 61/653,610, which was filed on May 31, 2012, and is included herein by reference.

### BACKGROUND

The present invention relates to channel coding, and more particularly, to a method for performing channel coding type control, and to an associated apparatus.

According to the 3rd Generation Partnership Project (3GPP) specifications, in a specified Transport Format Set (TFS), the channel coding type of a Transport Channel (TrCH) is fixed. Herein the term “coding” may mean any of encoding and decoding. More specifically, no matter what the block size of the TrCH is, the TrCH is encoded by the same channel coding type. For example, for the Transport Format (TF) of “A×B” with A and B respectively representing the number of transport blocks and the transport block size in a situation where A=1 and B=0, i.e. the TF of “1×0”, it is composed of 16 Cyclic Redundancy Check (CRC) bits only, and the convolutional coding should be utilized according to the 3GPP specifications. In addition, for the TF of “A×B” in a situation where A=1 and B=244, i.e. the TF of “1×244”, it is composed of 244 information bits and 16 CRC bits, and the aforementioned convolutional coding should be utilized according to the 3GPP specifications.

Implementing in this manner may prevent confusion for many service providers and mobile device manufacturers. However, some problems may occur. For example, the system capacity is limited due to the fixed channel coding type. In another example, the power consumption is high due to the fixed channel coding type. Thus, a novel method is required for improving the system capacity and reducing the power consumption.

### SUMMARY

It is therefore an objective of the claimed invention to provide a method for performing channel coding type control, and to provide an associated apparatus, in order to solve the above-mentioned problems.

It is another objective of the claimed invention to provide a method for performing channel coding type control, and to provide an associated apparatus, in order to utilize code-block-size-dependent channel coding types. As a result, the channel coding gain can be increased, and therefore the goal of improving the system capacity and reducing the power consumption can be achieved.

According to at least one preferred embodiment, a method for performing channel coding type control is provided, where the method is applied to an electronic device, the method comprising: obtaining a code block size to be used during channel encoding for a Transport Format (TF); comparing the code block size with at least one predetermined threshold to generate at least one comparison result; selecting a specific channel coding type from a plurality of channel coding types according to the at least one comparison result; and utilizing the specific channel coding type during channel encoding for the TF.

According to at least one preferred embodiment, an apparatus for performing channel coding type control is provided, where the apparatus comprises at least one portion of an electronic device. The apparatus comprises a processing circuit, and the processing circuit comprises at least one wireless control module and a channel coding type control module. The at least one wireless control module is arranged to perform wireless communications control for the electronic device. In addition, the channel coding type control module is arranged to obtain, from the at least one wireless control module, a code block size to be used during channel encoding performed by the at least one wireless control module for a TF, compare the code block size with at least one predetermined threshold to generate at least one comparison result, and select a specific channel coding type from a plurality of channel coding types according to the at least one comparison result. Additionally, the at least one wireless control module is arranged to utilize the specific channel coding type during channel encoding for the TF. For example, the processing circuit can be implemented with at least one computer processor executing program instructions. In particular, the apparatus may further comprise a transmitter coupled to (more particularly, electrically connected to) the processing circuit, where the transmitter is arranged to transmit encoded data generated during channel encoding performed by the at least one wireless control module.

According to at least one preferred embodiment, a method for performing channel coding type control is provided, where the method is applied to an electronic device, the method comprising: obtaining a code block size to be used during channel decoding for a TF; comparing the code block size with at least one predetermined threshold to generate at least one comparison result; selecting a specific channel coding type from a plurality of channel coding types according to the at least one comparison result; and utilizing the specific channel coding type during channel decoding for the TF.

According to at least one preferred embodiment, a method for performing channel coding type control is provided, where the method is applied to an electronic device, the method comprising: obtaining all possible code block sizes to be used during channel decoding for a Transport Channel (TrCH); comparing the aforementioned all possible code block sizes with at least one predetermined threshold, respectively, in order to generate at least one comparison result for each possible code block size; selecting a specific channel coding type from a plurality of channel coding types for the aforementioned each possible code block size according to the at least one comparison result; and utilizing the specific channel coding type for the aforementioned each possible code block size during channel decoding for the TrCH.

According to at least one preferred embodiment, a method for performing channel coding type control is provided, where the method is applied to an electronic device, the method comprising: receiving encoded data of a TF and at least one information element (IE) corresponding to a specific channel coding type from a transmitter within another electronic device, wherein the specific channel coding type is previously selected from a plurality of channel coding types during channel encoding for the TF within the other electronic device, and the at least one IE comprises an entry indicating the specific channel coding type utilized during channel encoding for the TF; and utilizing the specific channel coding type during channel decoding for the TF.

According to at least one preferred embodiment, an apparatus for performing channel coding type control is provided, where the apparatus comprises at least one portion of an electronic device. The apparatus comprises a processing circuit, and the processing circuit comprises at least one wireless control module and a channel coding type control module. The at least one wireless control module is arranged to perform wireless communications control for the electronic device. In addition, the channel coding type control module is arranged to obtain, from the at least one wireless control module, a code block size to be used during channel decoding performed by the at least one wireless control module for a TF, compare the code block size with at least one predetermined threshold to generate at least one comparison result, and select a specific channel coding type from a plurality of channel coding types according to the at least one comparison result. Additionally, the at least one wireless control module is arranged to utilize the specific channel coding type during channel decoding for the TF. For example, the processing circuit can be implemented with at least one computer processor executing program instructions. In particular, the apparatus may further comprise a receiver coupled to (more particularly, electrically connected to) the processing circuit, where the receiver is arranged to receive encoded data of the TF from a transmitter within another electronic device, such as the encoded data generated during channel encoding of the TF within the other electronic device.

According to at least one preferred embodiment, an apparatus for performing channel coding type control is provided, where the apparatus comprises at least one portion of an electronic device. The apparatus comprises a processing circuit, and the processing circuit comprises at least one wireless control module and a channel coding type control module. The at least one wireless control module is arranged to perform wireless communications control for the electronic device. In addition, the channel coding type control module is arranged to obtain, from the at least one wireless control module, all possible code block sizes to be used during channel decoding performed by the at least one wireless control module for a TrCH, compare the aforementioned all possible code block sizes with at least one predetermined threshold, respectively, in order to generate at least one comparison result for each possible code block size, and select a specific channel coding type from a plurality of channel coding types for the aforementioned each possible code block size according to the at least one comparison result. Additionally, the at least one wireless control module is arranged to utilize the specific channel coding type for the aforementioned each possible code block size during channel decoding for the TrCH. For example, the processing circuit can be implemented with at least one computer processor executing program instructions. In particular, the apparatus may further comprise a receiver coupled to (more particularly, electrically connected to) the processing circuit, where the receiver is arranged to receive encoded data of the TrCH from a transmitter within another electronic device, such as the encoded data generated during channel encoding of the TrCH within the other electronic device.

According to at least one preferred embodiment, an apparatus for performing channel coding type control is provided, where the apparatus comprises at least one portion of an electronic device. The apparatus comprises a processing circuit and a receiver coupled to (more particularly, electrically connected to) the processing circuit, and the processing circuit comprises at least one wireless control module and a channel coding type control module. The at least one wireless control module is arranged to perform wireless communications control for the electronic device. In addition, the receiver is arranged to receive encoded data of a TF and at least one IE corresponding to a specific channel coding type from a transmitter within another electronic device, wherein the specific channel coding type is previously selected from a plurality of channel coding types during channel encoding for the TF within the other electronic device. Additionally, the channel coding type control module is arranged to parse the at least one IE comprising an entry indicating the specific channel coding type previously utilized during channel encoding for the TF, in order to detect the specific channel coding type and notify the at least one wireless control module of the specific channel coding type, and the at least one wireless control module is arranged to utilize the specific channel coding type during channel decoding for the TF. For example, the processing circuit can be implemented with at least one computer processor executing program instructions.

It is an advantage of the present invention that the present invention method and apparatus can utilize code-block-size-dependent channel coding types during channel encoding (or decoding), so the channel coding gain can be increased, and therefore the goal of improving the system capacity and reducing the power consumption can be achieved. As a result of applying the code-block-size-dependent channel coding, the system capacity can be improved and the power consumption can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing channel coding type control according to a first embodiment of the present invention.

FIG. 2 illustrates a flowchart of a method for performing channel coding type control according to an embodiment of the present invention.

FIG. 3 illustrates some implementation details involved with the method shown in FIG. 2 according to an embodiment of the present invention.

FIG. 4 is a diagram of an apparatus for performing channel coding type control according to a second embodiment of the present invention.

FIG. 5 illustrates a flowchart of a method for performing channel coding type control according to another embodiment of the present invention.

FIG. 6 illustrates a flowchart of a method for performing channel coding type control according to yet another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

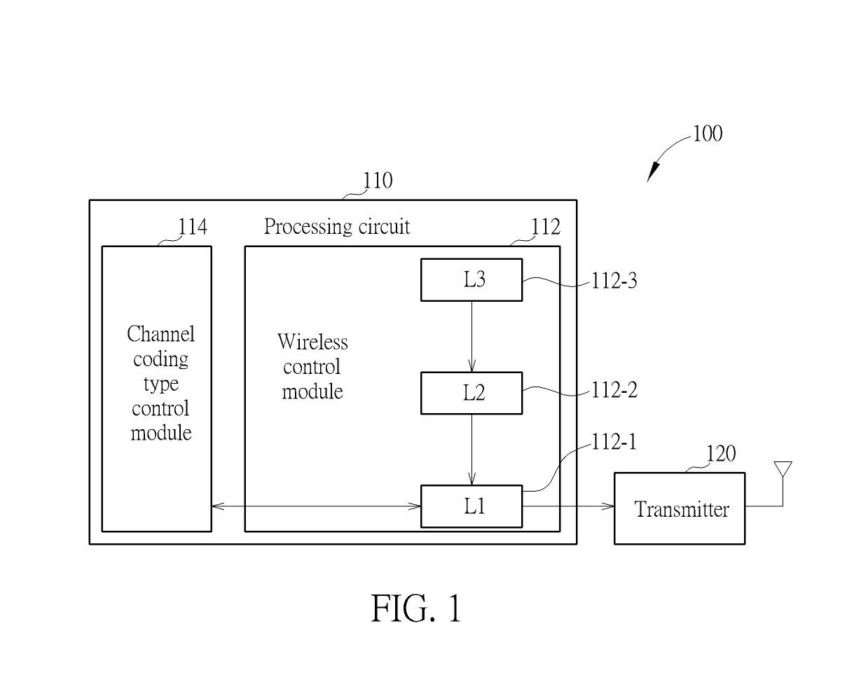

Please refer to FIG. 1, which illustrates a diagram of an apparatus 100 for performing channel coding type control according to a first embodiment of the present invention, where the apparatus 100 may comprise at least one portion (e.g. a portion or all) of an electronic device. In another example, the apparatus 100 may comprise a system (more particularly, a network control system or a telecommunications control system) comprising the electronic device mentioned above. Examples of the electronic device may include, but not limited to, a computer such as a server or a personal computer, and more particularly, a computer system of a Node B.

As shown in FIG. 1, the apparatus 100 may comprise a processing circuit 110, and may further comprise a transmitter 120 coupled to (more particularly, electrically connected to) the processing circuit 110, where the processing circuit 110 can be implemented with at least one computer processor executing program instructions and associated interfacing/control circuit(s). For example, the processing circuit 110 may comprise at least one wireless control module 112 which comprises multiple wireless control sub-modules 112-1, 112-2, and 112-3 (respectively labeled “L1”, “L2”, and “L3”, which stand for “Layer 1”, “Layer 2”, and “Layer 3”, respectively), and may further comprise a channel coding type control module 114. More particularly, the wireless control sub-module 112-1 may represent the physical layer (which can be referred to as “PHY”, for brevity). In practice, the wireless control sub-module 112-2 may represent the Media Access Control (MAC) and Radio Link Control (RLC) layer, and the wireless control sub-module 112-3 may represent the Radio Resource Control (RRC) layer. This is for illustrative purposes only, and is not meant to be a limitation of the present invention.

According to this embodiment, the aforementioned at least one wireless control module 112 is arranged to perform wireless communications control for the electronic device. In addition, the channel coding type control module 114 is capable of obtaining, from the aforementioned at least one wireless control module 112 (e.g. the wireless control sub-module 112-1), a code block size to be used during channel encoding performed by the aforementioned at least one wireless control module 112 for a Transport Format (TF), comparing the code block size with at least one predetermined threshold to generate at least one comparison result, and selecting a specific channel coding type from a plurality of channel coding types according to the aforementioned at least one comparison result. For example, there may be three channel coding types (e.g. the channel coding types of the repetition code, the convolutional code, and the turbo code). Additionally, the aforementioned at least one wireless control module 112 is arranged to utilize the specific channel coding type during channel encoding for the TF. As a result, the transmitter 120 is arranged to transmit encoded data generated during channel encoding performed by the aforementioned at least one wireless control module 112.

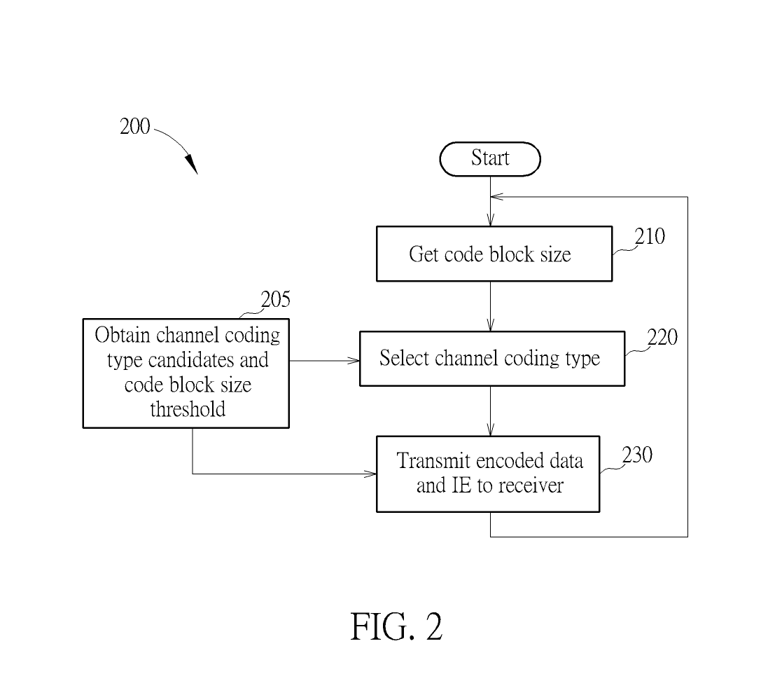

FIG. 2 illustrates a flowchart of a method 200 for performing channel coding type control according to an embodiment of the present invention. The method 200 shown in FIG. 2 can be applied to the apparatus 100 shown in FIG. 1, and more particularly, can be applied to the processing circuit 110 shown in FIG. 1. The method is described as follows.

In Step 205, the processing circuit 110 obtains (in advance, for example) some channel coding type candidates, such as the plurality of channel coding types mentioned above, and obtains at least one code block size threshold, such as the aforementioned at least one predetermined threshold. For example, the plurality of channel coding types and the aforementioned at least one predetermined threshold can be stored in a storage unit (not shown) of the electronic device in advance, and the processing circuit 110 may retrieve the plurality of channel coding types and the aforementioned at least one predetermined threshold from the storage unit mentioned above, where examples of the storage unit may include, but not limited to, a read only memory (ROM) or a non-volatile memory (e.g. a Flash memory) within the electronic device. In practice, the code block size threshold such as the aforementioned at least one predetermined threshold can be determined in advance by simulation during a design phase of the electronic device such as the aforementioned computer system of the Node B.

In Step 210, the channel coding type control module 114 gets the aforementioned code block size, which may depend on the transmission traffic. More specifically, the channel coding type control module 114 obtains, from the aforementioned at least one wireless control module 112 (e.g. the wireless control sub-module 112-1), the code block size to be used during channel encoding performed by the aforementioned at least one wireless control module 112 for a TF such as that mentioned above. For example, the code block under consideration (i.e. the code block having this code block size) may be composed of a Transport Channel (TrCH) block and Cyclic Redundancy Check (CRC) bits. In another example, the code block under consideration (i.e. the code block having this code block size) may be composed of one or more TrCH blocks and one or more associated sets of CRC bits, where the code block may be large enough to be encoded using the better coding type (e.g. the channel coding type of the turbo code) than others.

In Step 220, the channel coding type control module 114 selects a channel coding type such as the specific channel coding type mentioned above. More particularly, the channel coding type control module 114 compares the code block size with the aforementioned at least one predetermined threshold to generate the aforementioned at least one comparison result, and selects the specific channel coding type from the plurality of channel coding types mentioned above according to the aforementioned at least one comparison result. Thus, the aforementioned at least one wireless control module 112 can utilize the specific channel coding type during channel encoding for the TF, where the associated predetermined thresholds of code block size may be 50 (bits) and 160 (bits), respectively. If the current code block size (i.e. the code block size under consideration, such as the code block size mentioned in Step 210) is less than 50 bits, the channel coding type of the repetition code is selected. If the current code block size is greater than or equal to 50 bits and is less than 160 bits, the channel coding type of the convolutional code is selected. Otherwise, in a situation where the current code block size is greater than or equal to 160 bits, the channel coding type of the turbo code is selected.

In Step 230, under control of the processing circuit 110, the transmitter 120 transmits the aforementioned encoded data of the TF (i.e. the encoded data generated during channel encoding performed by the aforementioned at least one wireless control module 112) and at least one information element (IE) corresponding to the specific channel coding type to a receiver within another electronic device such as the so-called user equipment (UE) (not shown in any of FIG. 1 and FIG. 2), in order to configure the other electronic device such as the UE to decode the encoded data according to the aforementioned at least one IE. For example, the aforementioned at least one IE may comprise an entry (e.g. one bit) indicating whether the feature of code-block-size-dependent channel coding type is activated during channel encoding for the TF. This is for illustrative purposes only, and is not meant to be a limitation of the present invention. According to some variations of this embodiment, it is unnecessary to implement with the entry indicating whether the feature of code-block-size-dependent channel coding type is activated during channel encoding for the TF, where the UE can be implemented by assuming that the feature of code-block-size-dependent channel coding type is always activated during channel encoding for the TF.

According to this embodiment, the aforementioned at least one IE may comprise an entry (e.g. one or more bits) indicating the aforementioned at least one predetermined threshold utilized during channel encoding for the TF. This is for illustrative purposes only, and is not meant to be a limitation of the present invention. According to some variations of this embodiment, in a situation where the aforementioned at least one predetermined threshold is static (or static information), it is unnecessary to implement with the entry indicating the aforementioned at least one predetermined threshold utilized during channel encoding for the TF.

In addition, according to this embodiment, the aforementioned at least one IE may comprise an entry (e.g. one or more bits) indicating the plurality of channel coding types utilized as the channel coding type candidates during channel encoding for the TF. This is for illustrative purposes only, and is not meant to be a limitation of the present invention. According to some variations of this embodiment, in a situation where the plurality of channel coding types is static (or static information), it is unnecessary to implement with the entry indicating the plurality of channel coding types utilized as the channel coding type candidates during channel encoding for the TF.

In practice, when altering the existing Wideband Code Division Multiple Access (WCDMA) specification according to the present invention, any of the newly added entries can be simple. For example, only one or more bits are needed to implement with one or more of the entries disclosed above. In particular, only one bit is needed to activate the feature of code-block-size-dependent channel coding type at the receiver side (e.g. the UE), since the aforementioned at least one predetermined threshold and the candidates of coding types (e.g. the coding types of convolutional code and the turbo code) can be static information.

According to some variations of this embodiment, the aforementioned at least one IE may comprise an entry indicating the specific channel coding type utilized during channel encoding for the TF. Thus, for each TrCH in a Transport Format Set (TFS), the channel coding type for a TF such as that mentioned above can be specified by the aforementioned at least one IE. Although the extra entry may be larger, the communications network (more particularly, the aforementioned computer system of the Node B) may assign the channel coding type more freely.

According to some simulations results, turbo coding outperforms the aforementioned convolutional coding when the code block size is greater than 160 bits, and for a large TF (e.g. the TF of “A×B” with a greater value of the parameter B than others), the convolutional coding gain is worse than the turbo coding gain. Thus, in contrast to the related art, the present invention method and apparatus can greatly increase the channel coding gain to enhance the system capacity of the whole communications network and to reduce the required power consumption from each receiver, such as the receiver of the UE within the communications network.

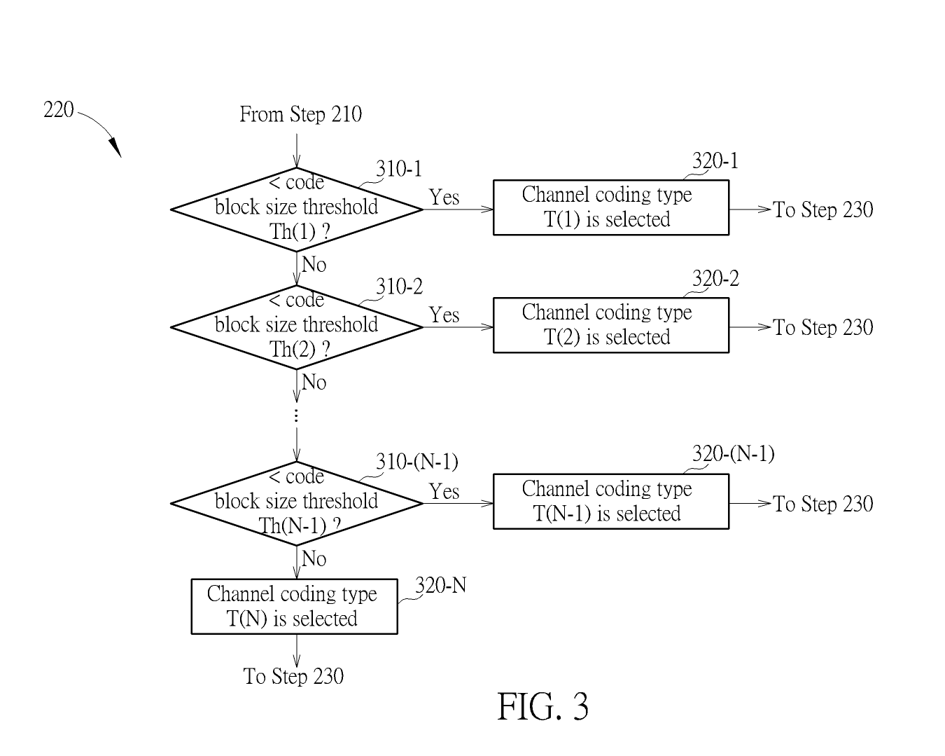

FIG. 3 illustrates some implementation details involved with the method 200 shown in FIG. 2 according to an embodiment of the present invention, where the steps shown in FIG. 3 can be regarded as sub-steps of Step 220 shown in FIG. 2. According to this embodiment, the aforementioned at least one predetermined threshold may comprise multiple (more particularly, (N−1)) code block size thresholds Th(1), Th(2), . . . , and Th(N−1), and the plurality of channel coding types mentioned above may comprise N channel coding types T(1), T(2), . . . , T(N−1), and T(N), where the notation N may represent a positive integer that is greater than two in this embodiment, and the sequence formed with the (N−1) code block size thresholds Th(1), Th(2), . . . , and Th(N−1) is strictly monotonically increasing, that is, Th(1)<Th(2)< . . . <Th(N−1).

In Step 310-1, the channel coding type control module 114 checks whether the code block size under consideration, such as the code block size to be used during channel encoding performed by the aforementioned at least one wireless control module 112 for the TF mentioned in Step 210, is less than the code block size threshold Th(1). If yes, Step 320-1 is entered; otherwise, Step 310-2 is entered. In a situation where Step 320-1 is entered, the channel coding type control module 114 selects the channel coding type T(1) as the specific channel coding type mentioned above and then Step 230 is entered.

In Step 310-2, the channel coding type control module 114 checks whether the code block size under consideration is less than the code block size threshold Th(2). If yes, Step 320-2 is entered; otherwise, Step 310-3 is entered. In a situation where Step 320-2 is entered, the channel coding type control module 114 selects the channel coding type T(2) as the specific channel coding type mentioned above and then Step 230 is entered. The rest may be deduced by analogy.

In Step 310-(N−1), the channel coding type control module 114 checks whether the code block size under consideration is less than the code block size threshold Th(N−1). If yes, Step 320-(N−1) is entered; otherwise, Step 320-N is entered. In a situation where Step 320-(N−1) is entered, the channel coding type control module 114 selects the channel coding type T(N−1) as the specific channel coding type mentioned above and then Step 230 is entered. In a situation where Step 320-N is entered, the channel coding type control module 114 selects the channel coding type T(N) as the specific channel coding type mentioned above and then Step 230 is entered.

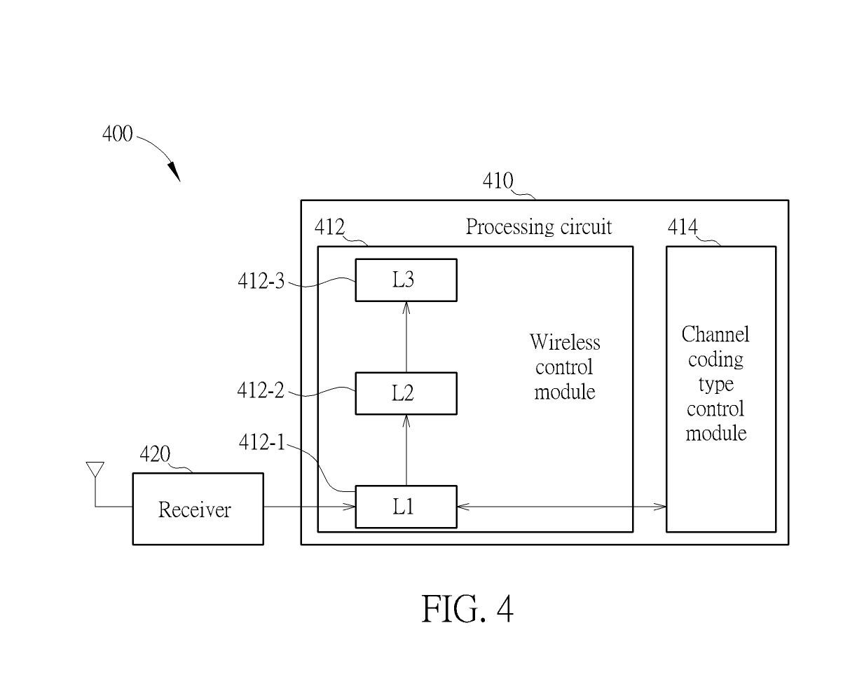

FIG. 4 is a diagram of an apparatus 400 for performing channel coding type control according to a second embodiment of the present invention, where the apparatus 400 may comprise at least one portion (e.g. a portion or all) of an electronic device, which can be the UE in this embodiment. Examples of this electronic device may include, but not limited to, a mobile phone (e.g. a multifunctional mobile phone), a mobile computer (e.g. tablet computer), a personal digital assistant (PDA), and a personal computer such as a laptop computer or desktop computer.

As shown in FIG. 4, the apparatus 400 may comprise a processing circuit 410, which can be implemented with at least one computer processor executing program instructions and associated interfacing/control circuit(s), and may further comprise a receiver 420 coupled to (more particularly, electrically connected to) the processing circuit 410. For example, the processing circuit 410 may comprise at least one wireless control module 412 which comprises multiple wireless control sub-modules 412-1, 412-2, and 412-3 (respectively labeled “L1”, “L2”, and “L3”, which stand for “Layer 1”, “Layer 2”, and “Layer 3”, respectively), and may further comprise a channel coding type control module 414. More particularly, the wireless control sub-module 412-1 may represent the physical layer (which can be referred to as “PHY”, for brevity). In practice, the wireless control module 412-2 may represent the MAC and RLC layer of the processing circuit 410, and the wireless control sub-module 412-3 may represent the RRC layer of the processing circuit 410, where the wireless control sub-modules 412-1, 412-2, and 412-3 perform operations in reverse order with respect to that of the wireless control sub-modules 112-1, 112-2, and 112-3 in FIG. 1, while this embodiment focuses on channel decoding, rather than channel encoding. This is for illustrative purposes only, and is not meant to be a limitation of the present invention.

According to this embodiment, the aforementioned at least one wireless control module 412 is arranged to perform wireless communications control for the electronic device. In addition, the channel coding type control module 414 is capable of obtaining, from the aforementioned at least one wireless control module 412 (e.g. the wireless control module 412-1), a code block size to be used during channel decoding performed by the aforementioned at least one wireless control module 412 for a TF such as that mentioned above, comparing the code block size with at least one predetermined threshold (e.g. the aforementioned predetermined threshold of the first embodiment) to generate at least one comparison result, and selecting a specific channel coding type from a plurality of channel coding types (e.g. the plurality of channel coding types of the first embodiment) according to the aforementioned at least one comparison result generated by the channel coding type control module 414. For example, in a situation where the electronic device of this embodiment (e.g. the UE) is designed to be compatible with the electronic device of the first embodiment (e.g. the aforementioned computer system of the Node B), the channel coding type control module 414 can typically select the same channel coding type from the plurality of channel coding types as that of the first embodiment according to the aforementioned at least one comparison result generated by the channel coding type control module 414. Additionally, the aforementioned at least one wireless control module 412 is arranged to utilize this specific channel coding type (which is selected by the channel coding type control module 414 in this embodiment) during channel decoding for the TF.

Please note that the receiver 420 is arranged to receive the encoded data of the TF from a transmitter within another electronic device, such as the transmitter 120 of the electronic device of the first embodiment, allowing the aforementioned at least one wireless control module 412 to decode the encoded data. More particularly, the receiver 420 is arranged to receive the encoded data of the TF and at least one IE corresponding to the specific channel coding type (more particularly, the IE received from the Node B) from the aforementioned transmitter within the other electronic device, such as the transmitter 120 of the electronic device of the first embodiment, allowing the aforementioned at least one wireless control module 412 to decode the encoded data according to the aforementioned at least one IE.

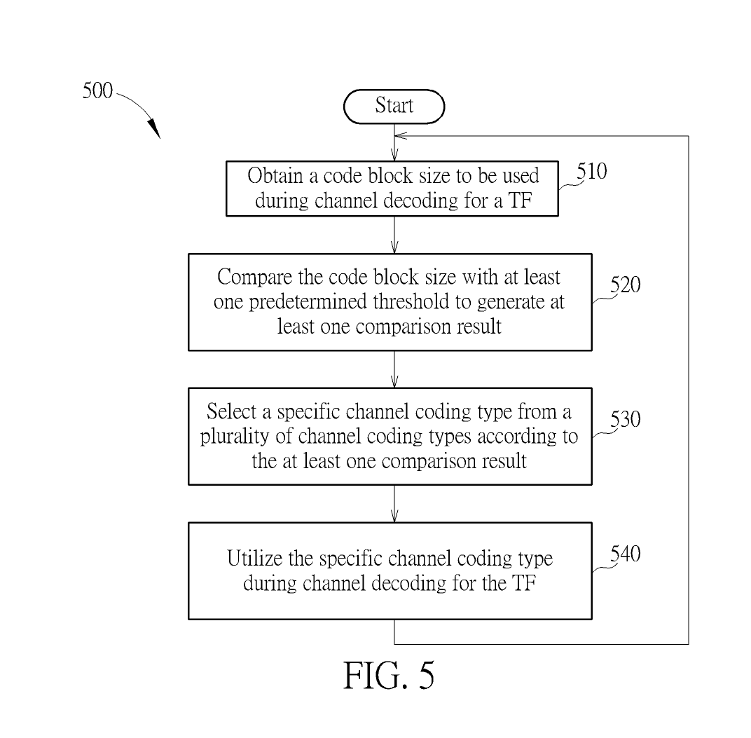

FIG. 5 illustrates a flowchart of a method 500 for performing channel coding type control according to another embodiment of the present invention. The method 500 shown in FIG. 5 can be applied to the apparatus 400 shown in FIG. 4, and more particularly, can be applied to the processing circuit 410 shown in FIG. 4. The method is described as follows.

In Step 510, the channel coding type control module 414 obtains, from the aforementioned at least one wireless control module 412 (e.g. the wireless control sub-module 412-1), the code block size to be used during channel decoding performed by the aforementioned at least one wireless control module 412 for a TF such as that mentioned in the embodiment shown in FIG. 4. For example, the code block under consideration (i.e. the code block having this code block size) may be the same as that mentioned in Step 210.

In Step 520, the channel coding type control module 414 compares the code block size mentioned in Step 510 with the aforementioned at least one predetermined threshold of the embodiment shown in FIG. 4 to generate the aforementioned at least one comparison result as disclosed in the embodiment shown in FIG. 4. According to this embodiment, in a situation where the electronic device of this embodiment (e.g. the UE) is designed to be compatible with the electronic device of the first embodiment (e.g. the aforementioned computer system of the Node B), the comparison result of Step 520 is typically the same as that of Step 220 when everything during transmission is correct.

In Step 530, the channel coding type control module 414 selects a specific channel coding type from a plurality of channel coding types such as the plurality of channel coding types mentioned in the embodiment shown in FIG. 4 (e.g. the channel coding type control module 414 selects the specific channel coding type mentioned in the embodiment shown in FIG. 4) according to the aforementioned at least one comparison result generated in Step 520. According to this embodiment, in a situation where the electronic device of this embodiment (e.g. the UE) is designed to be compatible with the electronic device of the first embodiment (e.g. the aforementioned computer system of the Node B), the specific channel coding type selected in Step 530 is typically the same as that of Step 220 when everything during transmission is correct.

In Step 540, the aforementioned at least one wireless control module 412 utilizes the specific channel coding type (which is selected in Step 530) during channel decoding for the TF.

According to this embodiment, the aforementioned at least one IE disclosed in Step 230 may be implemented at the transmitter side of this embodiment (e.g. the Node B), where the receiver 420 is arranged to receive the encoded data of the TF and the aforementioned at least one IE corresponding to the specific channel coding type from the aforementioned transmitter within the other electronic device (e.g. the transmitter 120), allowing the aforementioned at least one wireless control module 412 to decode the encoded data according to aforementioned the at least one IE. For example, the aforementioned at least one IE may comprise an entry (e.g. one bit) indicating whether the feature of code-block-size-dependent channel coding type is activated during channel coding for the TF. This is for illustrative purposes only, and is not meant to be a limitation of the present invention. According to some variations of this embodiment, it is unnecessary to implement with the entry indicating whether the feature of code-block-size-dependent channel coding type is activated during channel coding for the TF, where the UE can be implemented by assuming that the feature of code-block-size-dependent channel coding type is always activated during channel coding for the TF.

Please note that, according to this embodiment, the operations of Step 510, Step 520, and Step 530 are typically required. This is for illustrative purposes only, and is not meant to be a limitation of the present invention. According to some variations of this embodiment, the aforementioned at least one IE may comprise an entry indicating the specific channel coding type utilized during channel encoding for the TF. Thus, for each TrCH in a TFS, the channel coding type for a TF such as that mentioned above can be specified by the aforementioned at least one IE. As a result, the operations of Step 510, Step 520, and Step 530 can be omitted.

More particularly, the receiver 420 is arranged to receive the encoded data of the TF and the aforementioned at least one IE corresponding to the specific channel coding type mentioned in Step 220 from the transmitter 120 within the other electronic device (e.g. the aforementioned computer system of the Node B), where the specific channel coding type is previously selected from the plurality of channel coding types mentioned in Step 220 during channel encoding for the TF within the other electronic device (e.g. the aforementioned computer system of the Node B). Additionally, the channel coding type control module 414 is arranged to parse the aforementioned at least one IE comprising an entry indicating the specific channel coding type previously utilized during channel coding for the TF, in order to detect the specific channel coding type mentioned in Step 220 and notify the aforementioned at least one wireless control module 412 of the specific channel coding type (which is detected by parsing the aforementioned at least one IE in this embodiment), and the aforementioned at least one wireless control module 412 is arranged to utilize the specific channel coding type (which is obtained from the detection or parsing performed by the channel coding type control module 414) during channel decoding for the TF. For example, the processing circuit 410 can be implemented with at least one computer processor executing program instructions. In practice, the aforementioned at least one IE may comprise an entry indicating whether the feature of code-block-size-dependent channel coding type is activated during channel coding for the TF.

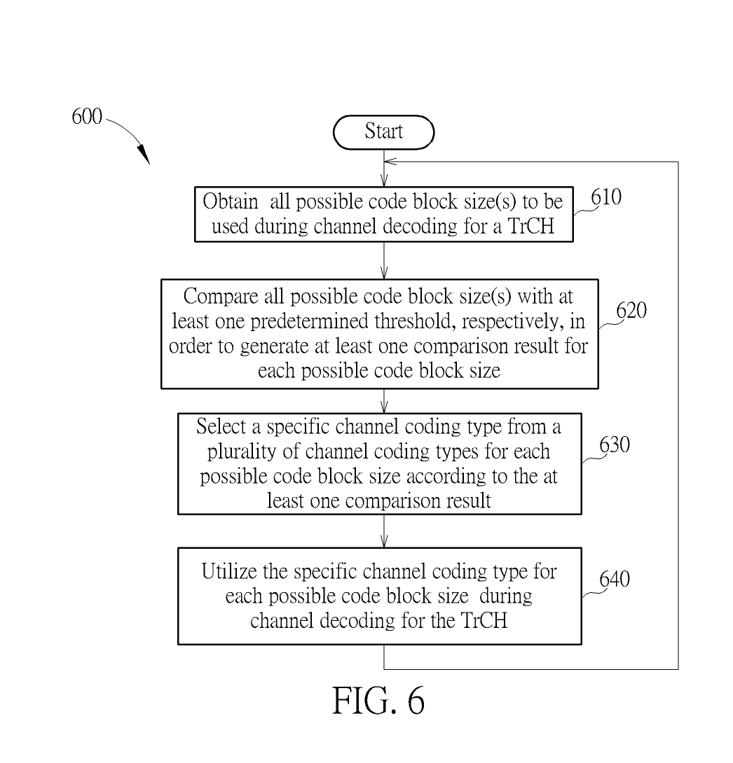

FIG. 6 illustrates a flowchart of a method 600 for performing channel coding type control according to yet another embodiment of the present invention. The method 600 shown in FIG. 6 can be applied to the apparatus 400 shown in FIG. 4, and more particularly, can be applied to the processing circuit 410 shown in FIG. 4. The method is described as follows.

In Step 610, the channel coding type control module 414 obtains, from the aforementioned at least one wireless control module 412 (e.g. the wireless control sub-module 412-1), all possible code block size(s) to be used during channel decoding performed by the aforementioned at least one wireless control module 412 for a TrCH such as the TrCH comprising the TF mentioned in the embodiment shown in FIG. 4. For example, in a situation where the received data carries the information of the Transport Format Combination Indicator (TFCI), when completing decoding the TFCI, the processing circuit 410 can directly obtain the code block size from the decoded result of the TFCI, and therefore, the aforementioned all possible code block size(s) of Step 610 can be regarded as the code block size mentioned in Step 510. That is, all possible code block size(s) in Step 610 may include only one code block size to be used during channel decoding for a TF of the TrCH, such as the code block size mentioned in Step 510. In another example, in a situation where the received data does not carry any information of the TFCI, the processing circuit 410 performs Blind Transport Format Detection (BTFD) to try decoding the received data with the aforementioned all possible code block size(s), such as a plurality of possible code block sizes to be used during channel decoding performed by the aforementioned at least one wireless control module 412 for the TrCH, where the processing circuit 410 can determine that one of the plurality of possible code block sizes is the correct code block size when the associated decoding result passes the CRC check.

In Step 620, the channel coding type control module 414 compares all possible code block size(s) mentioned in Step 610 with the aforementioned at least one predetermined threshold of the embodiment shown in FIG. 4, respectively, in order to generate at least one comparison result for each possible code block size, such as the aforementioned at least one comparison result mentioned in Step 520. For example, in a situation where the received data carries the information of the TFCI mentioned above, all possible code block size(s) of Step 610 can be regarded as the code block size mentioned in Step 510, and the aforementioned at least one comparison result for each possible code block size in Step 620 can be regarded as the aforementioned at least one comparison result mentioned in Step 520. In another example, in a situation where the received data does not carry any information of the TFCI, the processing circuit 410 performs the BTFD to try decoding the received data with all possible code block size(s) such as the plurality of possible code block sizes, and the channel coding type control module 414 compares the plurality of possible code block sizes with the aforementioned at least one predetermined threshold of the embodiment shown in FIG. 4, respectively, in order to generate the aforementioned at least one comparison result for each possible code block size.

In Step 630, the channel coding type control module 414 selects a specific channel coding type from a plurality of channel coding types such as the plurality of channel coding types mentioned in the embodiment shown in FIG. 4 for each possible code block size according to the aforementioned at least one comparison result generated in Step 620. For example, in a situation where the received data carries the information of the TFCI mentioned above, all possible code block size(s) of Step 610 can be regarded as the code block size mentioned in Step 510, and the operation performed in Step 630 is equivalent to the operation performed in Step 530. In another example, in a situation where the received data does not carry any information of the TFCI, the processing circuit 410 performs the BTFD to try decoding the received data with the aforementioned all possible code block size(s) such as the plurality of possible code block sizes, and the channel coding type control module 414 may select, from the plurality of channel coding types, respective specific channel coding types for the plurality of possible code block sizes according to respective comparison results generated in Step 620 for the plurality of possible code block sizes, respectively.

In Step 640, the aforementioned at least one wireless control module 412 utilizes the specific channel coding type for each possible code block size (i.e. the specific channel coding type selected in Step 630) during channel decoding for the TrCH mentioned in Step 610. For example, in a situation where the received data carries the information of the TFCI mentioned above, the aforementioned all possible code block size(s) of Step 610 can be regarded as the code block size mentioned in Step 510, and the specific channel coding type mentioned in Step 630 can be regarded as the specific channel coding type mentioned in Step 530, and therefore the operation performed in Step 640 is equivalent to the operation performed in Step 540. In another example, in a situation where the received data does not carry any information of the TFCI, the processing circuit 410 performs the BTFD to try decoding the received data with all possible code block size(s) such as the plurality of possible code block sizes, and the channel coding type control module 414 may utilizes the respective specific channel coding types for the plurality of possible code block sizes during channel decoding for the TrCH mentioned in Step 610.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing channel coding type control, the method being applied to at least one portion of an electronic device, the method comprising:
obtaining a code block size to be used during channel encoding for a Transport Format (TF);
comparing the code block size with at least one predetermined threshold to generate at least one comparison result;
selecting a specific channel coding type from a plurality of channel coding types according to the at least one comparison result; and
utilizing the specific channel coding type during channel encoding for the TF.

2. The method of claim 1, further comprising:
transmitting encoded data of the TF and at least one information element (IE) corresponding to the specific channel coding type to a receiver within another electronic device, in order to configure the other electronic device to decode the encoded data according to the at least one IE.

3. The method of claim 2, wherein the at least one IE comprises an entry indicating whether a feature of code-block-size-dependent channel coding type is activated during channel encoding for the TF.

4. The method of claim 2, wherein the at least one IE comprises an entry indicating the at least one predetermined threshold utilized during channel encoding for the TF.

5. The method of claim 2, wherein the at least one IE comprises an entry indicating the plurality of channel coding types utilized as channel coding type candidates during channel encoding for the TF.

6. The method of claim 2, wherein the at least one IE comprises an entry indicating the specific channel coding type utilized during channel encoding for the TF.

7. A method for performing channel coding type control, the method being applied to at least one portion of an electronic device, the method comprising:
obtaining all possible code block sizes to be used during channel decoding for a Transport Channel (TrCH);
comparing said all possible code block sizes with at least one predetermined threshold, respectively, in order to generate at least one comparison result for each possible code block size;
selecting a specific channel coding type from a plurality of channel coding types for said each possible code block size according to the at least one comparison result; and
utilizing the specific channel coding type for said each possible code block size during channel decoding for the TrCH.

8. The method of claim 7, further comprising:
receiving encoded data of a Transport Format (TF) of the TrCH and at least one information element (IE) corresponding to the specific channel coding type from a transmitter within another electronic device, in order to decode the encoded data according to the at least one IE.

9. The method of claim 8, wherein the at least one IE comprises an entry indicating whether a feature of code-block-size-dependent channel coding type is activated during channel encoding for the TF.

10. The method of claim 8, wherein the at least one IE comprises an entry indicating the at least one predetermined threshold; and the at least one predetermined threshold is previously utilized during channel encoding for the TF.

11. The method of claim 8, wherein the at least one IE comprises an entry indicating the plurality of channel coding types; and the channel coding types are previously utilized as channel coding type candidates during channel encoding for the TF.

12. A method for performing channel coding type control, the method being applied to at least one portion of an electronic device, the method comprising:
receiving encoded data of a Transport Format (TF) and at least one information element (IE) corresponding to a specific channel coding type from a transmitter within another electronic device, wherein the specific channel coding type is previously selected from a plurality of channel coding types during channel encoding for the TF within the other electronic device;
parsing the at least one IE comprising an entry indicating the specific channel coding type previously utilized during channel encoding for the TF, in order to detect the specific channel coding type; and
utilizing the specific channel coding type during channel decoding for the TF.

13. The method of claim 12, wherein the at least one IE comprises an entry indicating whether a feature of code-block-size-dependent channel coding type is activated during channel encoding for the TF.

14. An apparatus for performing channel coding type control, the apparatus comprising at least one portion of an electronic device, the apparatus comprising:
a processing circuit, wherein the processing circuit comprises:
at least one wireless control module arranged to perform wireless communications control for the electronic device; and
a channel coding type control module arranged to obtain, from the at least one wireless control module, all possible code block sizes to be used during channel decoding performed by the at least one wireless control module for a Transport Channel (TrCH), compare said all possible code block sizes with at least one predetermined threshold, respectively, in order to generate at least one comparison result for each possible code block size, and select a specific channel coding type from a plurality of channel coding types for said each possible code block size according to the at least one comparison result;
wherein the at least one wireless control module is arranged to utilize the specific channel coding type for said each possible code block size during channel decoding for the TrCH.

15. The apparatus of claim 14, further comprising:
a receiver arranged to receive encoded data of a Transport Format (TF) of the TrCH and at least one information element (IE) corresponding to the specific channel coding type from a transmitter within another electronic device, allowing the at least one wireless control module to decode the encoded data according to the at least one IE.

16. The apparatus of claim 15, wherein the at least one IE comprises an entry indicating whether a feature of code-block-size-dependent channel coding type is activated during channel encoding for the TF.

17. The apparatus of claim 15, wherein the at least one IE comprises an entry indicating the at least one predetermined threshold; and the at least one predetermined threshold is previously utilized during channel encoding for the TF.

18. The apparatus of claim 15, wherein the at least one IE comprises an entry indicating the plurality of channel coding types; and the channel coding types are previously utilized as channel coding type candidates during channel encoding for the TF.

19. The apparatus of claim 14, further comprising:
a receiver arranged to receive encoded data of a Transport Format (TF) of the TrCH from a transmitter within another electronic device, allowing the at least one wireless control module to decode the encoded data.

20. The apparatus of claim 14, wherein the processing circuit is implemented with at least one computer processor executing program instructions.
